(19) United States
(12) Patent Application Publication
(10) Pub. No.: US 2015/0161824 A1
(43) Pub. Date: Jun. 11, 2015

(54) INDIRECT CHARACTERIZATION OF TRANSPORTATION NETWORKS AND VEHICLE HEALTH

(71) Applicant: IMS SOLUTIONS, INC., Schaumburg, IL (US)

(72) Inventors: William Ben Miners, Guelph (CA); Otman A. Basir, Waterloo (CA)

(21) Appl. No.: 14/566,320

(22) Filed: Dec. 10, 2014

Related U.S. Application Data
(60) Provisional application No. 61/914,017, filed on Dec. 10, 2013.

(51) Int. Cl. G07C 5/00; G01S 19/13

(52) U.S. Cl. CPC G07C 5/00; G01S 19/13

(57) ABSTRACT

A characterizes vehicle tire and road information using indirect internal vehicle information from emissions, infotainment, and communication subsystems. This approach to characterize vehicle tire and road information eliminates the need for additional sensors within the vehicle or infrastructure, while supporting the analysis across a broad base of existing vehicles. Several examples of this approach are described herein, although other uses could be implemented.

### BACKGROUND

As sensors are deployed throughout a vehicle, a wealth of information about the vehicle, its health, and movement can be directly measured and recorded. Typical applications of this information include event logging or event-data-recorders (EDR) to help reconstruct specific events, or GNSS-based navigation systems for turn-by-turn navigation. Unfortunately, only a small subset of vehicle characteristics is practical to directly measure using sensors within the vehicle. There are many characteristics, scenarios, and events that either cannot be sensed, or are impractical to directly measure.

### SUMMARY

A system and method disclosed herein characterizes vehicle tire and road information using indirect internal vehicle information from emissions, infotainment, and communication subsystems. This approach to characterize vehicle tire and road information is unique in eliminating the need for additional sensors within the vehicle or infrastructure, while supporting the analysis across a broad base of existing vehicles. Several examples of this approach are described herein, although other uses could be implemented.

Hydroplaning: Automatic detection of hydroplaning in one or more wheels, by cross-referencing externally derived speed information (i.e. GNSS) against internal vehicle speed sensor readings, engine load, and RPM. The increased wheel speed and recovery pattern provides cues that are indirectly identified through the comparison across multiple sources of speed, engine load, and RPM.

Ice and black ice detection: Similar to hydroplaning, a vehicle losing traction on icy surfaces is automatically detected through indirect sensor comparisons between external speed information (i.e. GNSS) and internal vehicle sensors (vehicle speed sensor/VSS, engine load, and RPM).

Tire wear: Vehicle speed measurements using the internal vehicle speed sensor (VSS) and external reference sources (GNSS) are used to characterize the vehicle using a known tire tread level. The deviation between vehicle speed measurements the external reference source (GNSS) is analyzed over time to indirectly measure tread wear.

Road surface identification: The frequency of vehicle vibrations and acoustic noise characteristics are applied to indirectly estimate the underlying road surface, whether it is paved with asphalt, concrete, gravel, or dirt. An initial automatic calibration process is employed to compensate for the unique vehicle-based vibration and acoustic characteristics.

Wheel misalignment detection: Deviations between wheel angle and bearing, in addition to vibration analysis while deceleration and accelerating help to characterize wheel misalignment without requiring dedicated sensors to measure wheel misalignment while the vehicle is in motion.

Automatic speedometer and odometer recalibration: Leveraging external reference sources (GNSS), the internal odometer and speedometer values are automatically recalibrated across typical driving speeds to compensate for changes in wheel size or tire type.

Traction characterization: Engagement of the vehicle's antilock braking system (ABS) during deceleration is detected in many vehicles using vibration and vehicle handling during deceleration.

Vehicle dynamics characterization: Learning the performance characteristics and vehicle dynamics from on road usage, derived from observations over time.

High winds: Automatic detection of external driving influences beyond visually observable conditions, including detecting high winds in specific road segments based on lateral vehicle movements.

Dynamic transportation network updates: Creation and updates to detailed road network details, including grade information, width, and travel speeds using aggregate information from sensors deployed in multiple vehicles.

### BRIEF DESCRIPTION OF THE DRAWINGS

The drawings can be briefly described as follows:

FIG. 1 is a schematic of hardware that can be used to implement the system and method of the present invention.

### DETAILED DESCRIPTION

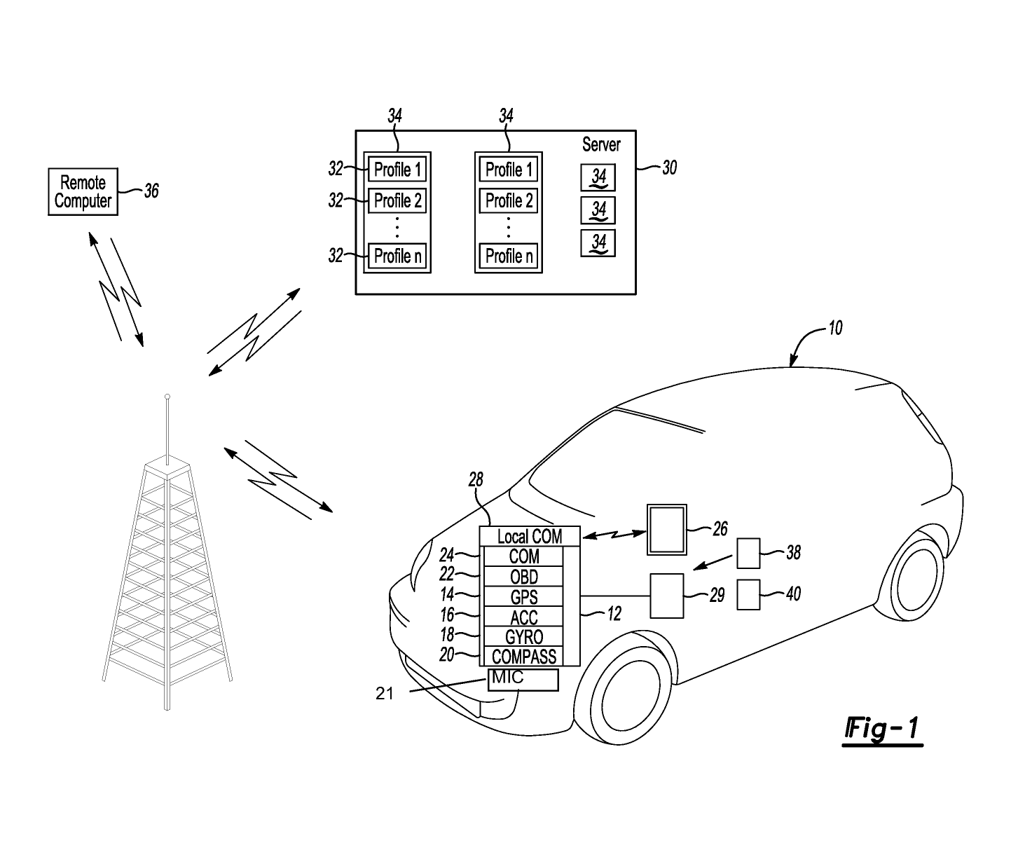

Referring to FIG. 1, a motor vehicle 10 includes a plurality of data gathering devices that communicate information to an appliance 12 installed within the vehicle 10. The example data gathering devices include a global positioning satellite (GNSS) receiver 14, a three-axis accelerometer 16, a gyroscope 18 and an electronic compass 20, which could be housed within the appliance 12 (along with a processor and suitable electronic storage, etc., suitably programmed to perform the functions described herein). The appliance 12 may also include a microphone 21. As appreciated, other data monitoring systems could be utilized within the contemplation of this invention. Data may also be collected from an onboard diagnostic port (OBD) 22 that provides data indicative of vehicle and vehicle engine operating parameters such as vehicle speed, engine speed, temperature, fuel consumption (or electricity consumption), engine idle time, car diagnostics and other information that is related to mechanical operation of the vehicle. Moreover, any other data that is available to the vehicle could also be communicated to the appliance 12 for gathering and compilation of the operation summaries of interest in categorizing the overall operation of the vehicle. Not all of the sensors mentioned here are necessary, however, as they are only listed as examples.

The appliance 12 may also include a communication module 24 (such as cell phone, satellite, wi-fi, etc.) that provides a connection to a wide-area network (such as the internet). Alternatively, the communication module 24 may connect to a wide-area network (such as the internet) via a user's cell phone 26 or other device providing communication via a local communication circuit 28 (e.g. Bluetooth). A card reader 29 is also in communication with the appliance 12 in the vehicle. The card reader 29 may be a barcode reader or magnetic stripe reader, nfc reader, etc or any kind of reader that could read information from a driver's license 38.

The in vehicle appliance 12 gathers data from the various sensors mounted within the vehicle 10 and stores that data. The in vehicle appliance 12 transmits this data (or summaries or analyses thereof) as a transmission signal through a wireless network to a server 30 (also having at least one processor and suitable electronic storage and suitably programmed to perform the functions described herein). The server 30 utilizes the received data to categorize vehicle operating conditions in order to determine or track vehicle use. This data can be utilized for tracking and determining driver behavior, insurance premiums for the motor vehicle, tracking data utilized to determine proper operation of the vehicle and other information that may provide value such as alerting a maintenance depot or service center when a specific vehicle is in need of such maintenance. Driving events and driver behavior are recorded by the server 30, such as fuel and/or electricity consumption, speed, driver behavior (acceleration, speed, etc.), distance driven and/or time spent in certain insurance-risk coded geographic areas. For example, the on-board appliance 12 may record the amount of time or distance in high-risk areas or low-risk areas, or high-risk vs. low risk roads. The on-board appliance 12 may collect and transmit to the server 30 (among other things mentioned herein): Speed, Acceleration, Distance, Fuel consumption, Engine Idle time, Car diagnostics, Location of vehicle, Engine emissions, etc.

The server 30 includes a plurality of profiles 32, each associated with a vehicle 10 (or alternatively, with a user). Among other things, the profiles 32 each contain information about the vehicle 10 (or user) including some or all of the gathered data (or summaries thereof). Some or all of the data (or summaries thereof) may be accessible to the user via a computer 32 over a wide area network (such as the internet) via a policyholder portal, such as fuel efficiency, environmental issues, location, maintenance, etc.

The user may be able to access some information in his profile 32, such as from a remote computer 36 (or the user's mobile device 26 via a browser or dedicated app) via a wide area network, such as the internet. The user can also customize some aspects of the profile 32.

It should be noted that the server 30 may be numerous physical and/or virtual servers at multiple locations. The server 30 may collect data from appliances 12 from many different vehicles 10 associated with a many different insurance companies and many different licensing organizations (e.g. government organizations responsible for licensing drivers). Each may configure parameters only for their own users, although information may be shared or replicated between an insurance company and a government organization. The server 30 permits the administrator of each insurance company to access only data for their policyholders. The server 30 permits the administrator of each licensing authority to access only data for their drivers. The server 30 permits each user to access only his own profile and receive information based upon only his own profile.

The server 30 may not only reside in traditional physical or virtual servers, but may also coexist with the on-board appliance, or may reside within a mobile device. In scenarios where the server 30 is distributed, all or a subset of relevant information may be synchronized between trusted nodes for the purposes of aggregate statistics, trends, and geo-spatial references (proximity to key locations, groups of drivers with similar driving routes).

As sensors are deployed throughout a vehicle, a wealth of information about the vehicle, its health, and movement can be directly measured and recorded. Typical applications of this information includes event logging or event-data-recorders (EDR) to help reconstruct specific events, or GNSS-based navigation systems for turn-by-turn navigation. Unfortunately, only a small subset of vehicle characteristics are practical to directly measure using sensors within the vehicle. There are many characteristics, scenarios, and events that either cannot be sensed, or are impractical to directly measure, including tire and road characterization.

The vehicle monitoring system characterizes vehicle tire and road information using indirect internal vehicle information from emissions, infotainment, and communication subsystems. This approach to characterize vehicle tire and road information is unique in eliminating the need for additional sensors within the vehicle or infrastructure, while supporting the analysis across a broad base of existing vehicles. Information is gathered by the appliance 12 and may be analyzed either by the onboard processor or by the server 30 to provide the analysis described below.

Hydroplaning: Automatic detection of hydroplaning in one or more wheels, by cross-referencing externally derived speed information (i.e. GNSS) against internal vehicle speed sensor readings, engine load, and RPM, all available from OBD 22. The increased wheel speed and recovery pattern provides cues that are indirectly identified through the comparison across multiple sources of speed, engine load, and RPM. When hydroplaning, the wheel speed (from OBD 22) increases relative to the GNSS 14 derived speed, then suddenly drops as the vehicle 10 regains traction. Logic is encoded in membership functions to detect this pattern, and can be extended to improve reliability by measuring an increase in RPM with a minimal increase in engine load (both from OBD 22) during hydroplaning (very low road resistance).

Ice and black ice detection: Similar to hydroplaning, a vehicle 10 losing traction on icy surfaces is automatically detected through indirect sensor comparisons between external speed information (i.e. GNSS 14) and internal vehicle sensors (vehicle speed sensor/VSS, engine load, and RPM, all available through OBD 22). Sudden changes in the difference indicate the vehicle 10 has lost traction on ice. Ice may still exist in some scenarios, but may not be detected if the vehicle 10 was simply coasting at the time it crossed the ice, or if the vehicle 10 had studded tires/chains on its tires. When traveling over ice, the RPMs often increase slightly, and vehicle speed (VSS from OBD 22) increases, but the engine load (from OBD 22) does not increase as much as one would expect to overcome vehicle 10 inertia using friction against a paved or gravel surface. Using RPM and engine load information helps to improve the accuracy of estimating the existence of ice. This approach is valuable since it can be applied to vehicles 10 on the road today without adding additional (somewhat expensive) black ice sensors.

Tire wear: Vehicle speed measurements using the internal vehicle speed sensor (VSS from OBD 22) and external reference sources (GNSS 14) are used to characterize the vehicle 10 using a known tire tread level. The deviation between vehicle speed measurements (from OBD 22) and the external reference source (GNSS 14) is analyzed over time to indirectly measure tread wear. Tire wear is estimated through gradual changes in the long-term average deviation between vehicle speed as measured through the vehicle speed sensor (tire rotation), which can be obtained from OBD 22 and speed as observed through external sources (GNSS 14). The rate of change in the deviation of speed between these two speed measures is proportional to the rate of tire wear in the vehicle 10. As the tire diameter decreases with tire wear, the vehicle speed measurement from OBD 22 increases relative to the actual speed or GNSS 14 derived speed. Changes in the speed deviations over time can be as much as 2% over the lifetime of the tire, reflecting the decrease in tread and tire diameter. The slow change in the deviation between VSS and GNSS based speed is used to assess changes in tire diameter and infer tire wear patterns. However, change in air pressure also impacts this measurement (because it affects tire diameter), which is why the changes in deviation between VSS and GNSS based speed are assessed over an extended duration—to compensate for short term tire pressure drops (and re-inflation). Temperature also has an impact since temperature changes the pressure within the tire, so temperature can be factored into the comparison. In vehicles where a full tire pressure monitoring system (TPMS) exists, the information can be used to compensate for deviations due to tire pressure. In vehicles without TPMS, or with an indirect TPMS approach, the estimation is less accurate and must be measured over intervals longer than the typical tire inflation cycle for the driver (i.e. 6 months).

Road surface identification: The frequency of vehicle vibrations and acoustic noise characteristics are applied to indirectly estimate the underlying road surface, whether it is paved with asphalt, concrete, gravel, or dirt. An initial automatic calibration process compensates for the unique vehicle-based vibration and acoustic characteristics. The frequency of vehicle vibrations and acoustic noise characteristics are measured with the microphone 21 and/or the accelerometers 16. If the accelerometers 16 are sufficiently sensitive in the low frequency range the microphone 21 is optional (although both microphone 21 and accelerometer 16 is preferred).

Wheel misalignment detection: Deviations between wheel angle and bearing, in addition to vibration analysis while deceleration and accelerating help to characterize wheel misalignment without requiring dedicated sensors to measure wheel misalignment while the vehicle is in motion. Wheel angle or ‘steering’ is available on the OBD 22 for most vehicles using manufacturer specific codes on the same physical OBD interface 22. This information is not part of the standard OBD specification but is available in many OEM specific extensions. Bearing is determined from GNSS 14 (i.e. observed externally). Changes in bearing are normally closely correlated to changes in wheel angle. With a ‘centered steering angle’ on a flat road with correctly aligned wheels, the vehicle 10 should maintain a relatively consistent bearing. When the wheels are misaligned, the vehicle 10 bearing typically deviates. These measurements must be observed over longer durations to compensate for temporary conditions like ‘high winds’.

Automatic speedometer and odometer recalibration: Leveraging external reference sources (GNSS 14), the internal odometer and speedometer values (both available from OBD 22) are automatically recalibrated across typical driving speeds to compensate for changes in wheel size or tire type.

Traction characterization: Engagement of the vehicle's antilock braking system (ABS) during deceleration is detected sensing higher frequency vibration with accelerometers 16 and vehicle handling during deceleration. In some vehicles 10, this information may already be available on the ODB 22.

Vehicle dynamics characterization: Learning the performance characteristics and vehicle dynamics from on road usage, derived from observations over time. Volumetric efficiency (VE) is derived in the absence of direct observable sensors. Once VE is determined, fuel efficiency can be estimated for each journey. Each vehicle 10 has specific performance curves correlating power, volumetric efficiency, temperature, and speed. In vehicles 10 where fuel efficiency cannot be measured directly, the performance curves can be roughly estimated using observations of vehicle 10 performance over extended durations of time. Of the above parameters, volumetric efficiency is the one that is seldom available as a direct measurement. This vehicle dynamics characterization approach estimates VE by comparing measured RPM, speed, and engine load values (from ODB 22) over time to build the VE curves for the specific vehicle.

High winds: Automatic detection of external driving influences beyond visually observable conditions, including detecting high winds in specific road segments based on lateral vehicle movements.

Dynamic transportation network updates: Creation and updates to detailed road network details, including grade information, width, and travel speeds using aggregate information from sensors deployed in multiple vehicles. Lateral movements are detected by the accelerometers 16 (gusts of wind, and sudden shifts). The steering angle (from ODB 22) is used as a secondary cue for persistent high winds—an offset steering angle with a consistent GNSS 14 bearing implies there is an external lateral force acting on the vehicle 10 to keep it traveling straight. The assumption is wind for this external lateral force.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A vehicle monitoring system comprising:
at least one internal sensor on a vehicle, the at least one sensor gathering internal vehicle data;
at least one external sensor on the vehicle, the at least one external sensor gathering external vehicle data;
a processor programmed to compare the internal vehicle data to the external vehicle data.

2. The vehicle monitoring system of claim 1 wherein the processor is programmed to determine tire wear based upon the comparison between the internal vehicle data and the external vehicle data.

3. The vehicle monitoring system of claim 2 wherein the at least one external sensor includes a GNSS receiver and the at least one internal sensor obtains vehicle speed information via an OBD port on the vehicle.

4. The vehicle monitoring system of claim 1 wherein the processor is programmed to determine road conditions based upon the comparison between the internal vehicle data and the external vehicle data.

5. The vehicle monitoring system of claim 4 wherein the at least one external sensor includes a GNSS receiver and the at least one internal sensor obtains internal vehicle data via an OBD port on the vehicle.

6. The vehicle monitoring system of claim 1 wherein the processor is programmed to determine an icy road based upon the comparison between the internal vehicle data and the external vehicle data.

7. The vehicle monitoring system of claim 6 wherein the at least one external sensor includes a GNSS receiver and the at least one internal sensor obtains internal vehicle data via an OBD port on the vehicle.

8. The vehicle monitoring system of claim 1 wherein the processor is programmed to determine wheel misalignment based upon the comparison between the internal vehicle data and the external vehicle data.

9. The vehicle monitoring system of claim 8 wherein the at least one external sensor includes a GNSS receiver and the at least one internal sensor obtains internal vehicle data via an OBD port on the vehicle.

10. The vehicle monitoring system of claim 1 wherein the at least one external sensor includes a GNSS receiver.

11. The vehicle monitoring system of claim 1 wherein the at least one internal sensor includes an accelerometer.

12. The vehicle monitoring system of claim 1 wherein the at least one internal sensor includes an OBD port.

13. A method for monitoring a vehicle including the steps of:
a) gathering internal vehicle data from the vehicle;
b) gathering external vehicle data; and
c) comparing the internal vehicle data to the external vehicle data.

14. The method of claim 13 further including the step of determining tire wear based upon the comparison between the internal vehicle data and the external vehicle data.

15. The method of claim 13 further including the step of determining road conditions based upon the comparison between the internal vehicle data and the external vehicle data.

16. The method of claim 13 further including the step of determining an icy road based upon the comparison between the internal vehicle data and the external vehicle data.

17. The method of claim 13 further including the step of determining wheel misalignment based upon the comparison between the internal vehicle data and the external vehicle data.

18. A method for monitoring a vehicle including the steps of:
a) gathering acceleration data or acoustic data from the vehicle; and
b) determining a road surface based upon the data gathered in said step a).

19. The method of claim 18 wherein said step a) includes gathering acoustic data and wherein said step b) includes determining the road surface based upon the acoustic data.

20. A method for determining volumetric efficiency of a vehicle including the steps of:
a) gathering vehicle data from an on-board data port; and
b) calculating volumetric efficiency based upon the vehicle data gathered in said step a).
